(19) United States
(12) Patent Application Publication
(10) Pub. No.: US 2010/0093952 A1
(43) Pub. Date: Apr. 15, 2010

(54) DEPOSIT DEACTIVATION TREATMENT METHOD

(75) Inventors: Hiroki Emoto, Okayama (JP); Kazuyuki Yokoyama, Okayama (JP)

Correspondence Address: OBLON, SPIVAK, MCCLELLAND MAIER & NEUSTADT, L.L.P., 1940 DUKE STREET, ALEXANDRIA, VA, 22314, US

(73) Assignee: Mitsubishi Chemical Corporation, Minato-ku (JP)

(21) Appl. No.: 12/519,234

(22) PCT Filed: Oct. 25, 2007
(86) PCT No.: PCT/JP2007/070851

§ 371 Date: Jun. 15, 2009

(30) Foreign Application Priority Data
Dec. 28, 2006 (JP) 2006-354735

(51) Int. Cl. C08F 2/00

(52) U.S. Cl. 526/78

(57) ABSTRACT

The object of the present invention is to provide a treatment method which deactivates deposits in a reactor and the like in a production process of an α-olefin low polymer. The present invention relates to that after completion of the production of a low polymer of ethylene in a reactor 10 in the presence of a chromium series catalyst, a hydrocarbon compound solution containing an electron donative compound such as water or alcohol is supplied to the reactor 10 and a heat exchanger 16, thereby deactivating the deposits.

### TECHNICAL FIELD

The present invention relates to a deposit deactivation treatment method. More particularly, it relates to a deposit deactivation treatment method in a production process of an α-olefin low polymer.

### BACKGROUND ART

Conventionally, a production method in which an α-olefin low polymer mainly comprising 1-hexene is obtained in high yield and high selectivity using an α-olefin such as ethylene as a raw material and using a chromium series catalyst as a low polymerization catalyst is reported (see Patent Document 1).

Patent Document 1: JP-A-08-239419

### Disclosure of the Invention

Problems that the Invention is Solve

By the way, where by-production of a significant amount of a polymer is not avoided even by the above method, and an α-olefin is produced by a continuous reaction system, the by-produced polymer is adhered to a low polymerization reactor or apparatuses, and this disturbs continuous stable operation. Therefore, as the case may be, there is the necessity that the polymer is discharged outside the system by periodically opening the equipment.

On the other hand, the low polymerization catalyst generally is deactivated by a catalyst deactivator added to a reaction liquid discharged from the reaction system.

However, in the case of a continuous reaction system, incorporation of deactivating substances such as oxygen and moisture is strictly precluded. Therefore, there is the case that deposits of an active catalyst or polymer deposits having an active catalyst incorporated therein are accumulated in the inside of a reactor and a heat exchanger that removes reaction heat, by continuous operation over a long period of time.

Components of a low polymerization catalyst accumulated without conducting such a deactivation and adhered in an apparatus vigorously react with oxygen and the like in air, and may combust when an apparatus is opened.

The present invention has been made to solve the problems on safety in the above production method of a low polymer of an α-olefin.

Accordingly, an object of the present invention is to provide a treatment method which deactivates deposits in a reactor and the like in a production process of an α-olefin low polymer.

### Means for Solving the Problems

As a result of extensive and intensive investigations to solve the above problems, the present inventors have reached to achieve the present invention. That is, the gist of the present invention resides in the following (1) to (7).

(1) A deposit deactivation treatment method which treats deposits accumulated in the inside of a reactor and/or in the inside of a heat exchanger for removing reaction heat in the reactor in producing a low polymer of an α-olefin by a continuous reaction system in a solvent supplied to the reactor in the presence of a chromium series catalyst, characterized in that:

after stopping operation of the equipment (reactor and/or heat exchanger), the deposits and an electron donative compound (provided that the chromium series catalyst present in the reactor at the time of the production is excluded) are contacted.

(2) The deposit deactivation treatment method described in (1), characterized in that the electron donative compound is a compound having an active methylene group or a functional group represented by the following general formula in the chemical formula:

—X—H [Chem. 1]

(wherein X represents a hetero atom, and H represents hydrogen.)

(3) The deposit deactivation treatment method described in (1), characterized in that the electron donative compound is at least one selected from water, alcohols, phenols, carboxylic acids, amines, ammonia and acetylacetone.

(4) The deposit deactivation treatment method described in any one of (1) to (3), characterized in that the electron donative compound is dissolved in a hydrocarbon compound.

(5) The deposit deactivation treatment method described in any one of (1) to (4), characterized in that the chromium series catalyst is constituted of a combination of a chromium compound (a), a nitrogen-containing compound (b) and an aluminum-containing compound (c).

(6) The deposit deactivation treatment method described in any one of (1) to (4), characterized in that the chromium series catalyst is constituted of a combination of at least a chromium compound (a), a nitrogen-containing compound (b), an aluminum-containing compound (c) and a halogen-containing compound (d).

(7) The deposit deactivation treatment method described in any one of (1) to (6), characterized in that the α-olefin is ethylene.

According to the present invention, there is provided a deposit deactivation treatment method which treats deposits accumulated in the inside of a reactor and/or in the inside of a heat exchanger for removing reaction heat in the reactor in producing a low polymer of an α-olefin by a continuous reaction system in a solvent supplied to the reactor in the presence of a chromium series catalyst, characterized in that after completion of the production in the reactor, the deposits and an electron donative compound (provided that the chromium series catalyst present in the reactor at the time of the production is excluded) are contacted.

The electron donative compound used in the deposit deactivation treatment method to which the present invention is applied is preferably a compound having an active methylene group or a functional group represented by the following general formula in its chemical formula:

—X—H [Chem. 2]

(wherein X represents a hetero atom, and H represents hydrogen.)

The electron donative compound is preferably at least one selected from water, alcohols, phenols, carboxylic acids, amines, ammonia and acetylacetone.

The electron donative compound is preferably dissolved in a hydrocarbon compound.

The chromium series catalyst used in the deposit deactivation treatment method to which the present invention is applied is preferably constituted of a combination of a chromium compound (a), a nitrogen-containing compound (b) and an aluminum-containing compound (c).

In the present invention, one constituted of a combination of at least a chromium compound (a), a nitrogen-containing compound (b), an aluminum-containing compound (c) and a halogen-containing compound (d) can be used as the chromium series catalyst.

In the present invention, the α-olefin is preferably ethylene.

### Advantage of the Invention

According to the present invention, deposits in a production process of an α-olefin low polymer is deactivated.

### BRIEF DESCRIPTION OF THE DRAWING

FIG. 1 is a view explaining a production flow example of an α-olefin low polymer in the embodiment of the invention.

### DESCRIPTION OF REFERENCE NUMERALS AND SIGNS

10 Reactor

10a Stirring machine

10b Pump

10c Filter

11, 22, 32, 41, 42, 51 Piping

11a Deactivator supply piping

11b Piping

11c Piping

12 First supply piping

12a Ethylene supply piping

13 Second supply piping

13a Catalyst supply piping

13b Solvent pump

14 Third supply piping

15 Fourth supply piping

21, 31 Circulation piping

16 Heat exchanger

16a Condenser

17 Compressor

20 Degassing tank

30 Ethylene separation column

40 High boiling separation column

50 Hexene separation column

52 Solvent circulation piping

60 Solvent drum

### BEST MODE FOR CARRYING OUT THE INVENTION

The best mode for carrying out the invention (hereinafter, the embodiment of the invention) is described in detail below. The invention is not limited to the following embodiment, and can be carried out with various modifications within a scope of its gist. Furthermore, the drawings used are to explain the present embodiment, and do not show the actual size.

### (α-Olefin)

In the production method of an α-olefin low polymer to which the embodiment of the invention is applied, the α-olefin used as a raw material includes substituted or unsubstituted α-olefins having from 2 to 30 carbon atoms. Specific examples of such an α-olefin include ethylene, propylene, 1-butene, 1-hexene, 1-octene, 3-methyl-1-butene and 4-methyl-1-pentene. In particular, ethylene is preferred as the α-olefin of a raw material, and when ethylene is used as the raw material, 1-hexene as a trimer of ethylene is obtained in high yield and high selectivity. Furthermore, when ethylene is used as the raw material, impurity components other than ethylene may be contained in the raw material. Specific impurity components include methane, ethane, acetylene and carbon dioxide. Those components are preferably in an amount of 0.1 mol % or less based on ethylene of the raw material.

### (Chromium Series Catalyst)

The chromium series catalyst is descried below. The chromium series catalyst used in the embodiment of the invention includes a catalyst constituted of a combination of at least a chromium compound (a), at least one nitrogen-containing compound (b) selected from the group consisting of an amine, an amide and an imide, and an aluminum-containing compound (c).

The chromium series catalyst used in the embodiment of the invention may contain a halogen-containing compound (d) as the fourth component according to need. Those catalyst components may be subjected to catalyst preadjustment for the purpose of improvement of catalytic activity. An electron donative solvent such as ethers such as tetrahydrofuran, diethylether and dimethoxyethane may be used for the catalyst preadjustment, but the catalyst preadjustment solvent which does not deactivate those catalysts is contained in the chromium series catalyst.

Each component is described below.

### (Chromium Compound (a))

The chromium compound (a) used in the embodiment of the invention includes at least one compound represented by the general formula CrXₙ. In the general formula, X represents an optional organic group or inorganic group, or a negative atom, and n is an integer of from 1 to 6, and is preferably 2 or more. When n is 2 or more, X may be the same or different.

Examples of the organic group include a hydrocarbon group having from 1 to 30 carbon atoms, a carbonyl group, an alkoxy group, a carboxyl group, a β-diketonate group, a β-ketocarboxyl group, a β-ketoester group and an amido group.

Examples of the inorganic group include chromium salt-forming groups such as a nitric acid group or a sulfuric acid group. Examples of the negative atom include oxygen and a halogen. A halogen-containing chromium compound is not included in the halogen-containing compound (d) described hereinafter.

The number of valency of chromium (Cr) is 0 to 6. The preferred chromium compound (a) includes a carboxylate of chromium (Cr). Specific examples of the carboxylate of chromium include chromium (II) acetate, chromium (III) acetate, chromium (III)-n-octanoate, chromium (III-2-ethylhexanoate, chromium (III) benzoate and chromium (III) naphthenate. Of those, chromium (III)-2-ethylhexanoate is particularly preferred.

### (Nitrogen-Containing Compound (b))

The nitrogen-containing compound (b) used in the embodiment of the invention includes at least one compound selected from the group consisting of an amine, an amide and an imide. Examples of the amine include a primary amine compound, a secondary amine compound and a mixture of those. Examples of the amide include a metal amide compound derived from a primary amine compound or a secondary amide compound, a mixture of those, and an acid amide compound. Examples of the imide include 1,2-cyclohexanedicarboxyimide, succinimide, phthalimide, maleimide and those metal salts.

The preferred nitrogen-containing compound (b) used in the embodiment of the invention includes a secondary amine compound. Specific examples of the secondary amine compound include pyrroles such as pyrrole, 2,4-dimethylpyrrole, 2,5-dimethylpyrrole, 2-methyl-5-ethylpyrrole, 2,5-dimethyl-3-ethylpyrrole, 3,4-dimethylpyrrole, 3,4-dichloropyrrole, 2,3,4,5-tetrachloropyrrole and 2-acetylpyrrole, and their derivatives. Examples of the derivative include metal pyrrolide derivatives. Specific examples of the metal pyrrolide derivative include diethylaluminum pyrrolide, ethylaluminum dipyrrolide, aluminum tripyrrolide, sodium pyrrolide, lithium pyrrolide, potassium pyrrolide, diethylaluminum(2,5-dimethylpyrrolide), ethylaluminum bis(2,5-dimethylpyrrolide), aluminum tris(2,5-dimethylpyrrolide), sodium(2,5-dimethylpyrrolide), lithium(2,5-dimethylpyrrolide) and potassium-(2,5-dimethylpyrrolide). Of those, 2,5-dimethylpyrrole and diethylaluminum(2,5-dimethylpyrrolide) are preferred. (Here, the aluminum pyrrolides are not included in the aluminum-containing compound (c). Furthermore, the halogen-containing pyrrole compound (b) is not included in the halogen-containing compound (d).)

### (Aluminum-Containing Compound (c))

The aluminum-containing compound (c) used in the embodiment of the invention includes at least one compound such as a trialkylaluminum compound, an alkoxyalkylaluminum compound and a hydrogenated alkylaluminum compound. Specific examples thereof include trimethylaluminum, triethylaluminum, triisobutylaluminum, diethylaluminum ethoxide and diethylaluminum hydride. Of those, triethylaluminum is particularly preferred.

### (Halogen-Containing Compound (d))

The chromium series catalyst used in the embodiment of the invention contains the halogen-containing compound (d) as the fourth component according to need. Examples of the halogen-containing compound (d) include at least one compound of a halogenated alkylaluminum compound, a linear halohydrocarbon with 2 or more carbon atoms having 3 or more halogen atoms and a cyclic halohydrocarbon with 3 or more carbon atoms having 3 or more halogen atoms. (The halogenated alkylaluminum compound is not included in the aluminum-containing compound (c)). Specific examples thereof include diethylaluminum chloride, ethylaluminum sesquichloride, carbon tetrachloride, 1,1,1-trichloroethane, 1,1,2,2-tetrachloroethane, pentachloroethane, hexachloroethane, 1,2,3-trichlorocyclopropane, 1,2,3,4,5,6-hexachlorocyclohexane and 1,4-bis(trichloromethyl)-2,3,5,6-tetrachlorobenzene.

In the embodiment of the invention, the low polymerization of an α-olefin is preferably that the α-olefin and the chromium series catalyst are contacted in an embodiment that the chromium compound (a) and the aluminum-containing compound (c) are not previously contacted, or the previous contact thereof is within 1 minute. Such a contact embodiment makes it possible to selectively conduct trimerization reaction of ethylene, thereby obtaining 1-hexene from ethylene as a raw material in high yield.

The contact embodiment in the above continuous reaction system includes the following (1) to (9).

(1) A method of simultaneously introducing a mixture of the catalyst components (a), (b) and (d) and the catalyst component (c) into a reactor, respectively.

(2) A method of simultaneously introducing a mixture of the catalyst components (b) to (d) and the catalyst component (a) into a reactor, respectively.

(3) A method of simultaneously introducing a mixture of the catalyst components (a) and (b) and a mixture of the catalyst components (c) and (d) into a reactor, respectively.

(4) A method of simultaneously introducing a mixture of the catalyst components (a) and (d) and a mixture of the catalyst components (b) and (c) into a reactor, respectively.

(5) A method of simultaneously introducing a mixture of the catalyst components (a) and (b), catalyst component (c) and the catalyst component (d) into a reactor, respectively.

(6) A method of simultaneously introducing a mixture of the catalyst components (c) and (d), catalyst component (a) and the catalyst component (b) into a reactor, respectively.

(7) A method of simultaneously introducing a mixture of the catalyst components (a) and (d) , catalyst component (b) and the catalyst component (c) into a reactor, respectively.

(8) A method of simultaneously introducing a mixture of the catalyst components (b) and (c), catalyst component (a) and the catalyst component (d) into a reactor, respectively.

(9) A method of simultaneously and independently introducing each of the catalyst components (a) to (d).

The above-described each catalyst component is generally dissolved in a solvent used in the reaction, and supplied to a reactor.

To remove uneven catalyst concentration in the reactor, the catalyst components or the mixtures in the above (1) to (9) can be supplied to a solvent supply piping (second supply piping 13), and a chromium series catalyst solution pre-mixed with a static mixer or the like can be supplied to the reactor.

The “embodiment that the chromium compound (a) and the aluminum-containing compound (c) are not previously contacted” is not limited to the initiation time of the reaction, and means that such an embodiment is maintained even in the supply of the subsequent additional α-olefin and catalyst component into the reactor.

Furthermore, in a batch reaction type, it is desired that the same embodiment is utilized.

The ratio of each constituent in the chromium series catalyst used in the embodiment of the invention is generally that the nitrogen-containing compound (b) is from 1 to 50 moles, and preferably from 1 to 30 moles, per mole of the chromium compound (a), and the aluminum-containing compound (c) is from 1 to 200 moles, and preferably from 10 to 150 moles, per mole of the chromium compound (a). When the halogen-containing compound (d) is contained in the chromium series catalyst, the halogen-containing compound (d) is from 1 to 50 moles, and preferably from 1 to 30 moles, per mole of the chromium compound (a).

In the embodiment of the invention, the amount of the chromium series catalyst used is not particularly limited, but is generally from 1.0×10⁻⁷ to 0.5 mole, preferably from 5.0×10⁻⁷ to 0.2 mole, and further preferably from 1.0×10⁻⁶ to 0.05 mole, in terms of chromium atom of the chromium compound (a) per 1 liter of the solvent described hereinafter.

By using such a chromium series catalyst, for example when ethylene is used as a raw material, hexene which is a trimer of ethylene can be obtained in selectivity of 90% or more. In this case, the proportion of 1-hexene occupied in hexene can be 99% or more.

### (Solvent)

In the production method of an α-olefin low polymer to which the embodiment of the invention is applied, the reaction of an α-olefin can be conducted in a solvent.

Such a solvent is not particularly limited. However, for example, chain saturated hydrocarbons or alicyclic saturated hydrocarbons, having from 1 to 20 carbon atoms, such as butane, pentane, 3-methylpentane, hexane, heptane, 2-methylhexane, octane, cyclohexane, methylcyclohexane, 2,2,4-trimethylpentane and decalin; and aromatic hydrocarbons such as benzene, toluene, xylene, ethylbenzene, mesitylene and tetralin are used. Furthermore, an α-olefin low polymer may be used as a solvent. Those can be used alone or as a mixed solvent.

In particular, the preferred solvent is chain saturated hydrocarbons or alicyclic saturated hydrocarbons, having from 4 to 10 carbon atoms. When those solvents are used, by-produced polymers such as a polyethylene can be suppressed. Furthermore, when the alicyclic saturated hydrocarbons are used, high catalyst activity tends to be obtained.

(Production Method of α-olefin Low Polymer)

The α-olefin low polymer used herein means an oligomer comprising a plurality of an α-olefin as a monomer being bonded. Specifically, it means a polymer comprising 2 to 10 of an α-olefin as a monomer being bonded.

Here, the production method of an α-olefin low polymer is described by referring to an example of the production of 1-hexene which is a trimer of ethylene as an α-olefin low polymer using ethylene as an α-olefin.

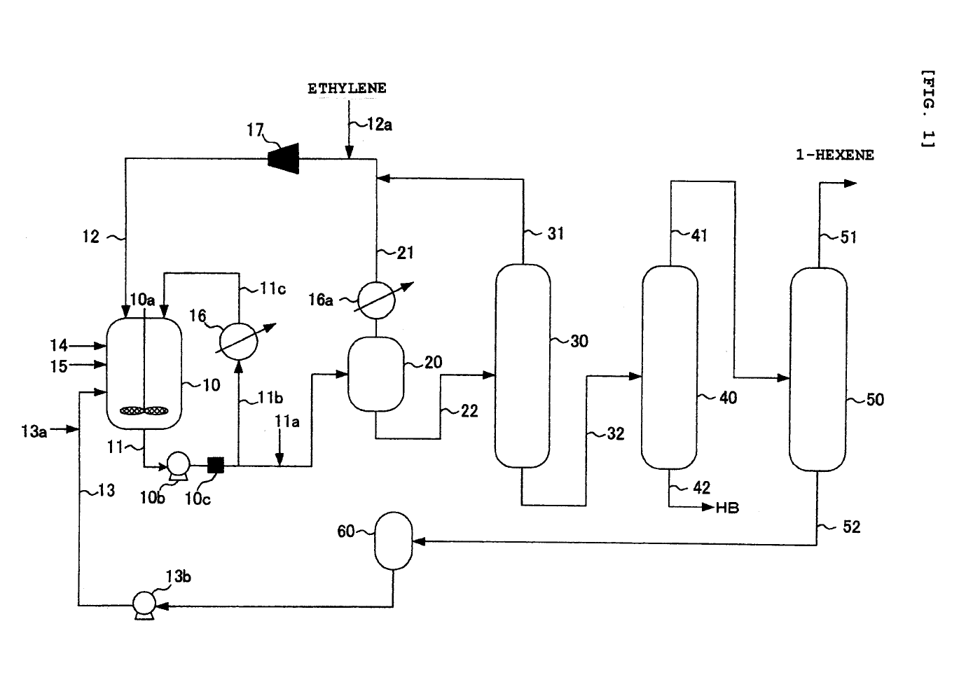

FIG. 1 is a view explaining a production flow example of an α-olefin low polymer in the embodiment of the invention. The production flow example of 1-hexene using ethylene as a raw material shown in FIG. 1 shows a reactor 10 in which ethylene is subjected to low polymerization in the presence of a chromium series catalyst, a heat exchanger 16 for removing reaction heat by circulating the reaction mixture, a degassing tank 20 that separates an unreacted ethylene gas from a reaction liquid withdrawn from the reactor 10, an ethylene separation column 30 that distills ethylene in the reaction liquid withdrawn from the degassing tank 20, a high boiling separation column 40 that separates a high boiling substance (hereinafter referred to as “HB” (high boiler)) in the reaction liquid withdrawn from the ethylene separation column 30, and a hexene separation column 50 that distills the reaction liquid withdrawn from the top of the high boiling separation column 40 to distill away 1-hexene.

Furthermore, a compressor 17 that circulates an unreacted ethylene separated in the degassing tank 20 and a condenser 16a into the reactor 10 via a circulation piping 21 is provided.

In FIG. 1, the reactor 10 includes the conventional reactors equipped with a stirring machine 10a, baffle, jacket and the like. As the stirring machine 10a, a stirring blade of the type such as paddle, pfaudler, propeller, turbine or the like is used in combination with a baffle such as a planar plate, a cylinder or a hairpin coil. The reactor 10 may not be equipped with the stirring machine 10a, baffle and jacket.

As shown in FIG. 1, ethylene is continuously supplied to the reactor 10 from an ethylene supply piping 12a via the compressor 17 and the first supply piping 12. Where the compressor 17 is, for example, two-stage compression system, a circulation piping 31 is connected to the first stage, and a circulation piping 21 is connected to the second stage, thereby making it possible to reduce electricity consumption. On the other hand, the chromium compound (a) and the nitrogen-containing compound (b) are supplied from the second supply piping 13 via a catalyst supply piping 13a, the aluminum-containing compound (c) is supplied from the third supply piping 14, and the halogen-containing compound (d) is supplied from the fourth supply piping 15. Furthermore, a solvent used in low polymerization reaction of ethylene is supplied to the reactor 10 from the second supply piping 13.

In the embodiment of the invention, the reaction temperature in the reactor 10 is generally from 0 to 250° C., preferably from 50 to 200° C., and more preferably from 80 to 170° C.

The reaction pressure is in a range of generally from normal pressures to 250 kgf/cm², preferably from 5 to 150 kgf/cm², and more preferably from 10 to 100 kgf/cm².

The trimerization reaction of ethylene is preferably conducted such that a molar ratio of 1-hexene to ethylene in the reaction liquid ((1-hexene in reaction liquid)/(ethylene in reaction liquid)) is from 0.05 to 1.5, and particularly from 0.10 to 1.0. Specifically, it is preferred that in the case of a continuous reaction, a catalyst concentration, a reaction pressure and other conditions are adjusted such that the molar ratio of 1-hexene to ethylene in the reaction liquid is in the above range, and in the case of a batchwise reaction, the reaction is stopped at the time that the molar ratio is in the above range. This has the tendency that by-production of components having a boiling point higher than that of 1-hexene is suppressed, thereby further increasing selectivity of 1-hexene.

The reaction liquid continuously withdrawn from the bottom of the reactor 10 via a piping 11 is that trimerization reaction of ethylene is stopped by a deactivator supplied from a deactivator supply piping 11a, and such a reaction liquid is supplied to the degassing tank 20. In the degassing tank 20, unreacted ethylene is degassed from the top thereof, and circulated and supplied to the reactor 10 via a circulation piping 21, the condenser 16a, the compressor 17 and the first supply piping 12. The reaction liquid from which unreacted ethylene has been degassed is withdrawn from the bottom of the degassing tank 20.

Operation conditions of the degassing tank 20 are that the temperature is generally from 0 to 250° C., and preferably from 50 to 200° C., and the pressure is generally from normal pressures to 150 kgf/cm², and preferably from normal pressures to 90 kgf/cm².

Subsequently, the reaction liquid from which unreacted ethylene gas has been degassed in the degassing tank 20 is withdrawn from the bottom of the degassing tank 20, and supplied to an ethylene separation column 30 by a piping 22. In the ethylene separation column 30, ethylene is distilled away from the column top by distillation, and circulated and supplied to the reactor 10 via a circulation piping 31 and the first supply piping 12. The reaction liquid from which ethylene has been removed is withdrawn from the bottom.

Operation conditions of the ethylene separation column 30 are that the top pressure is generally from normal pressures to 30 kgf/cm², and preferably from normal pressures to 20 kgf/cm², and the reflux ratio (R/D) is generally from 0 to 500, and preferably from 0.1 to 100.

The reaction liquid from which ethylene has been distilled in the ethylene separation column 30 is withdrawn from the bottom of the ethylene separation column 30, and supplied to the high boiling separation column 40 by a piping 32. In the high boiling separation column 40, high boiling components (HB: high boiler) are withdrawn from the bottom by a piping 42. A distillate from which high boiling components have been separated is withdrawn from the top by a piping 41.

Operation conditions of the high boiling separation column 40 are that the top pressure is generally from 0.1 to 10 kgf/cm², and preferably from 0.5 to 5 kgf/cm², and the reflux ratio (R/D) is generally from 0 to 100, and preferably from 0.1 to 20.

Subsequently, the reaction liquid withdrawn as a distillate from the top of the high boiling separation column 40 is supplied to the hexene separation column 50 by the piping 41. In the hexene separation column 50, 1-hexene by distillation is distilled from the top by a piping 51. Heptane is withdrawn from the bottom of the hexene separation column 50, and stored in a solvent drum 60 via a solvent circulation piping 52, and circulated and supplied as a reaction solvent to the reactor 10 via the second supply piping 13.

Operation conditions of the hexene separation column 50 are that the top pressure is generally from 0.1 to 10 kgf/cm², and preferably from 0.5 to 5 kgf/cm², and the reflux ratio (R/D) is generally from 0 to 100, and preferably from 0.1 to 20.

### (Deactivation Treatment Method of Deposits in Reactor and Heat Exchanger)

The deactivation treatment method of deposits in the reactor 10 and the heat exchanger 16 is described below.

In the embodiment of the invention, after completion of the production in the reactor 10 in a heptane solvent supplied to the reactor 10 in the presence of the chromium series catalyst, deposits in the reactor 10 and the heat exchanger 16 and an electron donative compound are contacted to deactivation treat the deposits.

In the present invention, deactivating deposits means to preliminarily treat the deposits such that the deposits do not generate heat even though exposed to air, or do not spontaneously combust. The embodiment that the deposits under the state (do not generate heat even though exposed to air, or do not spontaneously combust) are removed from the reaction system is included in the deactivation treatment of the present invention.

The embodiment that a plurality of a reactor and/or a heat exchanger for heat removal exists, for example, 2 series of a reactor and/or a heat exchanger for heat removal exist, is described below. One series of the reactor and/or the heat exchanger for heat removal is operated as a series for producing an α-olefin low polymer, and the other series is a series that is put on standby in a state of shutdown such that the series can always be operated as for emergency in the case that the reactor and/or the heat exchanger for heat removal during operation are urgently stopped due to trouble of equipment. In this case, where deposits are accumulated in the series during operation, the series during operation is separated from the production, and the equipment is stopped. The series on standby is operated, and deposits adhered to the equipment of the series stopped can be deactivation treated.

In the present invention, after stopping the operation, deposits adhered to the reactor and/or the heat exchanger, and the electron donative compound are contacted. The deposits may be deactivated by introducing the electron donative compound into the reactor and/or the heat exchanger during operation.

In the present invention, the deposits and the electron donative compound are preferably contacted before opening the reaction system. In opening the reaction system and conducting maintenance and inspection of equipment, when the deposits are previously deactivation treated in the reaction system, the troubles of heat generation and spontaneous combustion of deposits can be prevented from occurring when the reaction system was opened.

Examples of the deposit in the reactor 10 and the heat exchanger 16 include component compounds of the chromium series catalyst, a polyethylene by-produced in low polymerization of an α-olefin, and a polyethylene having component compounds of the chromium series catalyst incorporated therein. In particular, if deactivation treatment is not conducted, the aluminum-containing compound (c) such as an alkyl aluminum which is a component of the chromium series catalyst is likely to vigorously react with oxygen in air and combust.

The electron donative compound used in the embodiment of the invention is not particularly limited. Example of the electron donative compound includes a compound having at least one active methylene group or functional group represented by the following general formula in its chemical formula.

—X—H [Chem. 3]

(wherein X represents a hetero atom, and H represents hydrogen.)

Examples of the hetero atom (X) in the above chemical formula include oxygen, nitrogen, sulfur and phosphorus.

The chromium series catalyst present in the reactor 10 at the time of the production is excluded from the electron donative compound used in the embodiment of the invention.

For example, pyrroles that are often used as the nitrogen-containing compound (b) are that active hydrogen is generally pulled out by excess alkylaluminum or the like in the reactor 10 at the time of the production, and is therefore present in the form of a pyrolide. Therefore, pyrrolides in which active hydrogen has already been lost do not exhibit the effect to deactivation of deposits, and are excluded from the electron donative compound used in the embodiment of the invention. However, pyrroles having active hydrogen present therein exhibit the effect to deactivation of deposits, and therefore correspond to the electron donative compound used in the embodiment of the invention.

Specific examples of the electron donative compound include water, alcohols, phenols, carboxylic acids, amines, ammonia and acetylacetone. In particular, to improve safety when opening the reactor and/or the heat exchanger, it is preferred to use water which is not a dangerous material. When water is used as the electron donative compound, water may be supplied to the reaction system in the form of water vapor.

Further specific compounds are exemplified as follow. That is, examples of the alcohols include monohydric alcohols such as methanol, ethanol, 1-propanol, butanol, pentanol, hexanol, octanol, heptanol, octanol, nonanol and decanol (including branched alcohols such as isopropanol and 2-ethylhexanol); benzyl alcohol, ethylene glycol, trimethylene glycol, and propanediol.

Examples of the phenols include phenol, cresol and hydroquinone. Examples of the carboxylic acids include formic acid, acetic acid, propionic acid, butyric acid, valeic acid, hexanoic acid, heptanoic acid, octanoic acid, nonanoic acid, decanoic acid, benzoic acid, phenylacetic acid, phthalic acid, malonic acid, succinic acid, glutaric acid, adipic acid, acrylic acid, maleic acid, fumaric acid and salicylic acid.

Examples of the amines include primary amines such as methylamine, ethylamine, isopropylamine, cyclohexylamine, benzylamine, aniline and naphthylamine; secondary amines such as diethylamine, diiospropylamine, dicyclohexylamine, dibenzylamine, bis(trimethylsilyl)amine, morpholine, imidazole, indoline, indole, pyrrole, 2,4-dimethylpyrrole, 2,5-dimethylpyrrole, 2-methyl-5-ethylpyrrole, 2,5-dimethyl-3-ethylpyrrole, 3,4-dimethylpyrrole, 3,4-dichloropyrrole, 2,3,4,5-tetrachloropyrrole, 2-acetylpyrrole, pyrazole and pyrrolidine; ethylenediamine; and triethylamine.

In the embodiment of the invention, the electron donative compound is preferably dissolved in a given hydrocarbon compound, and used in a form of a solution. The hydrocarbon compound is not particularly limited so long as it dissolves the electron donative compound. Examples of the hydrocarbon compound include chain or alicyclic saturated hydrocarbon compounds having from 1 to 20 carbon atoms such as butane, pentane, 3-methylpentane, hexane, heptane, 2-methylhexane, octane, cyclohexane, methylcyclohexane, 2,2,4-trimethylpentane and decalin; and aromatic hydrocarbon compounds such as benzene, toluene, xylene, ethylbenzene, mesitylene and tetralin. Those can be use alone or as a mixed solvent.

When the electron donative compound is dissolved in a given hydrocarbon compound and is in a form of solution, the concentration of the electron donative compound in the solution is not particularly limited, but is generally from 0.0001 to 50% by weight, and preferably from 0.001 to 5% by weight.

In the embodiment of the invention, a method of contacting the deposits in the reactor 10 and the heat exchanger 16 with the electron donative compound after completion of the production in the reactor 10 is not particularly limited so long as it is a method in which the deposits are deactivated.

For example, a method of supplying the above-described solution of a hydrocarbon compound containing the electron donative compound to the reactor 10, and contacting the deposits in the reactor 10 with the electron donative compound by stirring with a stirring machine 10a is employed.

Furthermore, the deposits in the heat exchanger 16 and the electron donative compound can be contacted by withdrawing a solution of the hydrocarbon compound from the bottom of the reactor 10, and circulating the solution of the hydrocarbon compound through a piping 11, a pump 10b, a filter 10c and a piping 11b.

In the embodiment of the invention, the temperature where the solution of the hydrocarbon compound containing the electron donative compound is supplied to the reactor 10 before discharging the deposits outside the system is not particularly limited, but is in a range of generally from 0 to 200° C., and preferably from 20 to 150° C.

Where the solution of the hydrocarbon compound is circulated through piping 11, 11b and the like, linear velocity in a tube of the heat exchanger 16 is not particularly limited, but is generally 0.001 to 10 m/sec, and preferably from 0.01 to 5 m/sec.

### EXAMPLES

The present invention is described further specifically based on the Examples. However, the present invention is not limited to the following Examples so far as it does not depart from its gist.

### Reference Example 1

A continuous low polymerization reaction of ethylene is carried out in a process having the reactor 10, the heat exchanger 16, the degassing tank 20, the ethylene separation column 30, the high boiling separation column 40, the hexene separation column 50 and the solvent drum 60 which stores a circulation solvent, as shown in FIG. 1.

From the first supply piping 12, unreacted ethylene separated from the degassing tank 20 and the ethylene separation column 30 are continuously supplied together with ethylene freshly supplied from the ethylene supply piping 12a to the reactor 10 by the compressor 17. From the second supply piping 13, the recovered n-heptane solvent separated in the hexene separation column 50 is continuously supplied to the reactor 10 at a flow rate of 40 liters/hr via the solvent drum 60 (2 kgf/cm² nitrogen seal).

Next, an n-heptane solution containing chromium (III) 2-ethylhexanoate (a) and 2,5-dimethylpyrrole (b) is supplied from the catalyst supply piping 13a at a flow rate of 0.1 liter/hr, and is continuously supplied to the reactor 10 via the second supply piping 13. An n-heptane solution of triethylaluminum (c) is continuously supplied to the reactor 10 from the third supply piping 14 at a flow rate of 0.03 liter/hr. Furthermore, an n-heptane solution of hexachloroethane (d) is continuously supplied to the reactor 10 from the fourth supply piping 15 at a flow rate of 0.02 liter/hr.

The solution of each of catalyst components is supplied from a tank (not shown) sealed with nitrogen at 2 kgf/cm².

The catalyst is continuously supplied to the reactor 10 such that the molar ratio of each component is (a):(b):(c):(d)=1:6:120:2. The reaction conditions are 120° C. and 51 kgf/cm².

2-Ethylhexanol as a metal solubilizing agent is added to the reaction liquid continuously withdrawn from the reactor 10, from the deactivator supply piping 11a at a flow rate of 0.005 liter/hr, and such a reaction liquid is then successively treated in the degassing tank 20, the ethylene separation column 30, the high boiling separation column 40 and the hexene separation column 50.

After operation for 720 hours in this process, deposits adhered to the inner wall surface of the reactor 10 and the inner wall surface of tubes of the heat exchanger 16 are collected in nitrogen atmosphere.

### Example 1

A 500 ml autoclave dried in a dryer at 150° C. was assembled in heating, and was vacuum substituted with nitrogen. A catalyst feed pipe equipped with a rupture disk was fitted to the autoclave. 200 ml of a normal heptane solution containing 23.7 mg (0.249 mmol) of 2,5-dimethylpyrrole, 569 mg (4.98 mmol) of triethylaluminum and 19.7 mg (0.0831 mmol) of hexachloroethane was charged in the autoclave. 1 ml of a normal heptane solution containing 20.0 mg (0.0415 mmol) of chromium (III)-2-ethylhexanoate was charged in the catalyst feed pipe. The autoclave was heated to 80° C., and ethylene was introduced into the catalyst feed pipe.

After the rupture disk was ruptured by ethylene pressure, ethylene and chromium (III)-2-ethylhexanoate were introduced into the autoclave, thereby low polymerization of ethylene was initiated. Ethylene was introduced until pressure in the autoclave reached 35 kgf/cm², and low polymerization reaction was conducted while maintaining the pressure at 35 kgf/cm², and the temperature at 80° C. One hour later, ethylene was discharged from the autoclave while maintaining the reaction temperature at 80° C., and at the time that the pressure in the autoclave reached normal pressures, the reaction was stopped. Thereafter, a reaction liquid at 80° C. was withdrawn, and deposits remained in the autoclave were dried with nitrogen.

Next, 300 ml of water was added as a treating agent, followed by stirring at room temperature for 30 minutes. Thereafter, solid-liquid separation was conducted, and the deposits obtained were dried under nitrogen flow overnight, thereby removing the treating agent.

0.01 g of the deposits after treatment was collected, and charged in a measurement cell while maintaining nitrogen atmosphere, and measurement with a differential scanning calorimeter (DSC) was carried out. After substituting atmosphere in the cell with air in place of nitrogen, temperature was elevated at 10° C./min, and heat generation initiation temperature was obtained.

The results are shown in Table 1.

### Examples 2 to 4

The same operation as in Example 1 was conducted except for changing the treating agent to the treating agent shown in Table 1. The results of the heat generation initiation temperature are shown in Table 1.

### Comparative Example 1

In Example 1, the deposits were not treated with the treating agent, and measured with DSC. The results of the heat generation initiation temperature are shown in Table 1.

TABLE 1

| | | | DSC measurement |
|---|---|---|---|
| | | | result |
| | | | Heat generation |
| | | | initiation |
| | | Treating agent | temperature (° C.) |
| Example | 1 | Water | 204 |
| | 2 | 1 wt % 2-ethylhexanol/ | 167 |
| | | n-heptane solution | |
| | 3 | 1 wt % 2-ethylhexanoic acid/ | 188 |
| | | n-heptane solution | |
| | 4 | 1 wt % diethylamine/ | 159 |
| | | n-heptane solution | |
| Comparative | 1 | n-Heptane | 85 |
| Example | | | |

It is seen from the results shown in Table 1 that in the case that the treating agent contains the electron donative compound (Examples 1 to 4), the heat generation initiation temperature is high, and stability in air is improved. On the other hand, it is seen that in the case that the deposit is not treated with the treating agent containing the electron donative compound (Comparative Example 1), the heat generation initiation temperature is low, which is dangerous. In other words, because the deposits obtained in Reference Example 1 and the deposits obtained in the Examples are the deposits having the same composition, the same effect as in the Examples can be expected in the deposit obtained in the Reference Example 1.

Therefore, it is apparent that after 1-hexene as a low polymer of ethylene was produced by a continuous reaction system in the presence of a chromium series catalyst as shown in Reference Example 1, and an electron donative compound or a solution containing the electron donative compound is then supplied to the reactor 10 and the heat exchanger 16, deposits in the reactor 10 and the heat exchanger 16 can be deactivated. Furthermore, even though the reactor and/or the heat exchanger are opened for maintenance and/or inspection, thereby exposing the inside thereof to air outside the reaction system, the deposits do not combust, and the maintenance and/or inspection can safely be carried out.

While the invention has been described in detail and with reference to the specific embodiments thereof, it will be apparent to one skilled in the art that various changes and modifications can be made therein without departing from the spirit and scope thereof.

This application is based on Japanese Patent Application (Patent Application No. 2006-354735) filed Dec. 28, 2006, the entire contents thereof being hereby incorporated by reference.

### INDUSTRIAL APPLICABILITY

According to the present invention, deposits in a production process of an α-olefin low polymer are deactivated. Therefore, the industrial value of the present invention is remarkable.

1. A deposit deactivation treatment method which treats deposits accumulated in the inside of a reactor and/or in the inside of a heat exchanger for removing reaction heat in the reactor in producing a low polymer of an α-olefin by a continuous reaction system in a solvent supplied to the reactor in the presence of a chromium series catalyst, characterized in that:
after stopping operation of the equipment (reactor and/or heat exchanger), the deposits and an electron donative compound (provided that the chromium series catalyst present in the reactor at the time of the production is excluded) are contacted.

2. The deposit deactivation treatment method as claimed in claim 1, characterized in that the electron donative compound is a compound having an active methylene group or a functional group represented by the following general formula in its chemical formula:
—X—H [Chem. 1]
(wherein X represents a hetero atom, and H represents hydrogen.)

3. The deposit deactivation treatment method as claimed in claim 1, characterized in that the electron donative compound is at least one selected from water, alcohols, phenols, carboxylic acids, amines, ammonia and acetylacetone.

4. The deposit deactivation treatment method as claimed in claim 1, characterized in that the electron donative compound is dissolved in a hydrocarbon compound.

5. The deposit deactivation treatment method as claimed in claim 1, characterized in that the chromium series catalyst is constituted of a combination of a chromium compound (a), a nitrogen-containing compound (b) and an aluminum-containing compound (c).

6. The deposit deactivation treatment method as claimed in claim 1, characterized in that the chromium series catalyst is constituted of a combination of at least a chromium compound (a), a nitrogen-containing compound (b), an aluminum-containing compound (c) and a halogen-containing compound (d).

7. The deposit deactivation treatment method as claimed in claim 1, characterized in that the α-olefin is ethylene.
